(19) United States
(12) Patent Application Publication
(10) Pub. No.: US 2009/0138504 A1
(43) Pub. Date: May 28, 2009

(54) ELECTRONIC CALENDAR SCHEDULING METHOD

(75) Inventors: Kimilee S. Gile, Leominster, MA (US); Elaine I. Kuo, North Chelmsford, MA (US); Fang Lu, Billerica, MA (US); Corey McCaffrey, Boston, MA (US)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/944,765

(22) Filed: Nov. 26, 2007

(51) Int. Cl. G06F 17/30

(52) U.S. Cl. 707/104.1; 707/E17.005

(57) ABSTRACT

A method of applying an action to an electronic calendar entry is disclosed. The method includes specifying a criteria and an associated event action and determining if the electronic calendar entry meets the specified criteria. In response to determining that the electronic calendar entry meets the specified criteria, applying the associated event action to the electronic calendar entry.

### BACKGROUND OF THE INVENTION

1. Field of the Invention

This invention relates to personal information management systems, and particularly to calendar scheduling applications.

2. Description of Background

Personal information management systems include electronic calendar and scheduling applications for users to maintain appointment or event entries within the electronic calendar. Such calendar applications typically include an option to provide an alarm reminder that may be associated with a particular event. For example, the calendar application may provide an alarm reminder 1 hour prior to a scheduled meeting. Further, calendar applications typically allow selection of a default rule such that an alarm reminder is applied to every appointment or event entry. Therefore, typical calendar applications provide an ability to automatically apply an alarm reminder to all appointment or event entries. While existing calendar applications are suitable for their intended purpose there is a need in the art for a calendar and scheduling arrangement that advances the state of the art.

### SUMMARY OF THE INVENTION

An embodiment of the invention includes a method of applying an action to an electronic calendar entry. The method includes specifying a criteria and an associated event action and determining if the electronic calendar entry meets the specified criteria. In response to determining that the electronic calendar entry meets the specified criteria, applying the associated event action to the electronic calendar entry.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which allows a calendar application to automatically respond, via rule based processing, to attributes of each specific appointment or event entry and perform specific actions following determination that the attributes of the specific appointment or event entry meet specified criteria.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a block schematic diagram of a processing system in accordance with an embodiment of the invention.

FIG. 2 depicts a calendar entry user interface in accordance with an embodiment of the invention.

FIG. 3 depicts a rule creation user interface in accordance with an embodiment of the invention.

FIG. 4 depicts a flowchart of process steps of an embodiment of a method to apply an action to an electronic calendar entry in accordance with an embodiment of the invention.

The detailed description explains the preferred embodiments of the invention, together with advantages and features, by way of example with reference to the drawings.

### DETAILED DESCRIPTION OF THE INVENTION

An embodiment of the invention provides an electronic calendar application that is automatically responsive, via rule based processing, to attributes of each specific appointment or event entry to perform specific event actions following determination that the attributes of the specific appointment or event entry meets specified criteria. In an embodiment, a reminder alarm is automatically applied to a specific appointment or event entry based upon the attributes of the specific appointment or event.

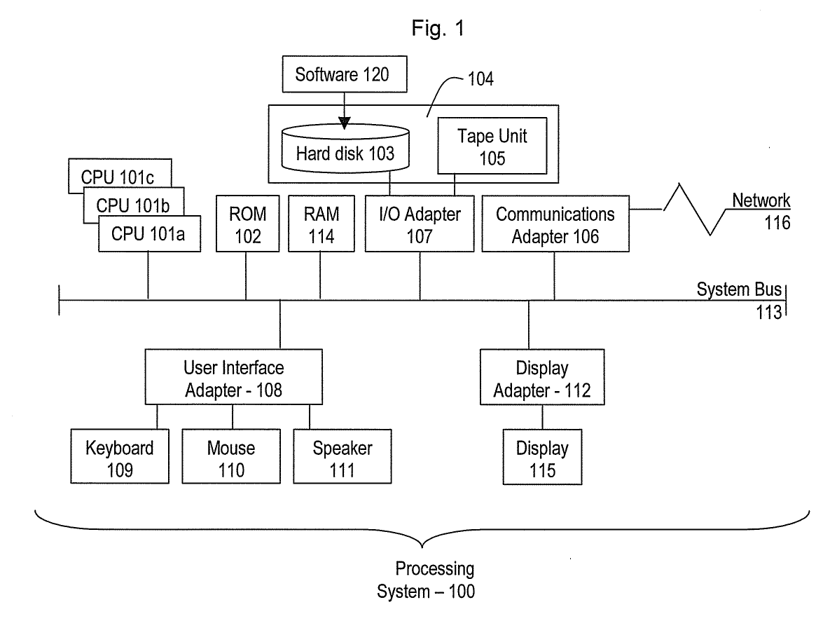

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing means in the form of processors 101, storage means including system memory 114 and mass storage 104, input means such as keyboard 109 and mouse 110, and output means including speaker 111 and display 115. In one embodiment, a portion of system memory 114 and mass storage 104 collectively store an operating system such as the AIX® operating system from IBM Corporation to coordinate the functions of the various components shown in FIG. 1.

It will be appreciated that the system 100 can be any suitable computer or computing platform, and may include a terminal, wireless device, information appliance, device, workstation, mini-computer, mainframe computer, personal digital assistant (PDA) or other computing device.

Examples of operating systems that may be supported by the system 100 include Windows 95, Windows 98, Windows NT 4.0, Windows XP, Windows 2000, Windows CE, Windows Vista, Macintosh, Java, LINUX, and UNIX, or any other suitable operating system. The system 100 also includes the network adapter or interface 106 for communicating over the network 116. The network 116 can be a local-area network (LAN), a metro-area network (MAN), or wide-area network (WAN), such as the Internet or World Wide Web.

Users of the system 100 can connect to the network 116 through any suitable network interface 106 connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 100 includes machine readable instructions stored on machine readable media (for example, the hard disk 103) for capture and interactive display of information shown on the screen 115 of a user. As discussed herein, the instructions are referred to as “software” 120. The software 120 may be produced using software development tools as are known in the art. Also discussed herein, the software 120 may also referred to as a “calendar application” 120 or other similar terms. The software 120 may include various tools and features for providing user interaction capabilities as are known in the art.

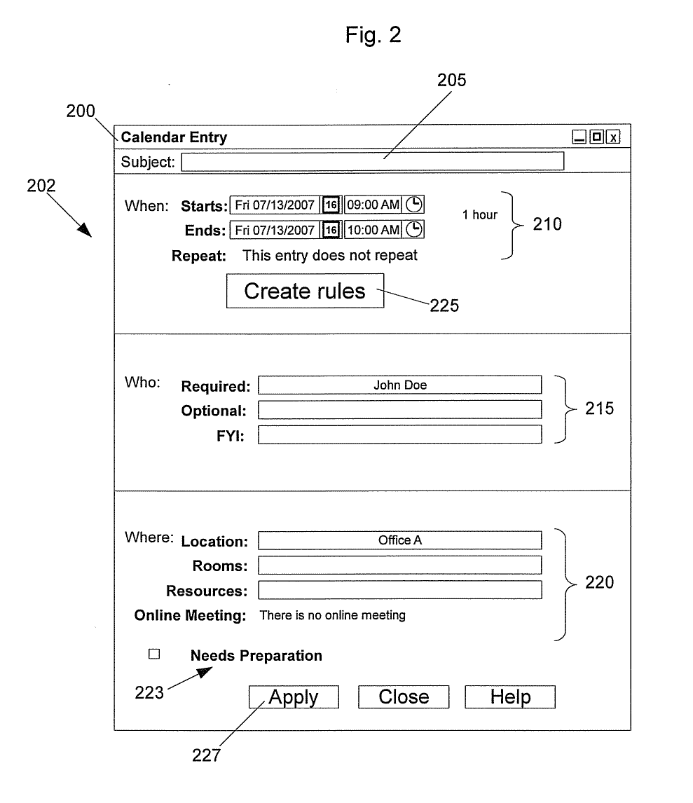

FIG. 2 depicts an embodiment of a user interface 200, such as an electronic calendar entry dialog for the creation of a calendar entry (referred to generally via reference number 202), for example. The calendar entry dialog 200 includes a subject or title field 205, appointment or event timing fields 210, participant fields 215, support fields 220, and a preparation status field 223, such as a “Needs Preparation” tag for example. An embodiment further includes a create rules selector 225, such as a selection box for example, for generating rules to apply to subsequent or future calendar entries 202. For example, in response to selection of an “Apply” button 227, information entered within fields 210, 215, 220, 223 is transferred into the calendar entry 202 for subsequent review and reference. Accordingly, as depicted in FIG. 2, subsequent to selection of the “Apply” button 227, a calendar entry 202 is created for an event on Friday, Jul. 13, 2007 from 9:00 AM to 10:00 AM that includes John Doe, and shall take place at Office A.

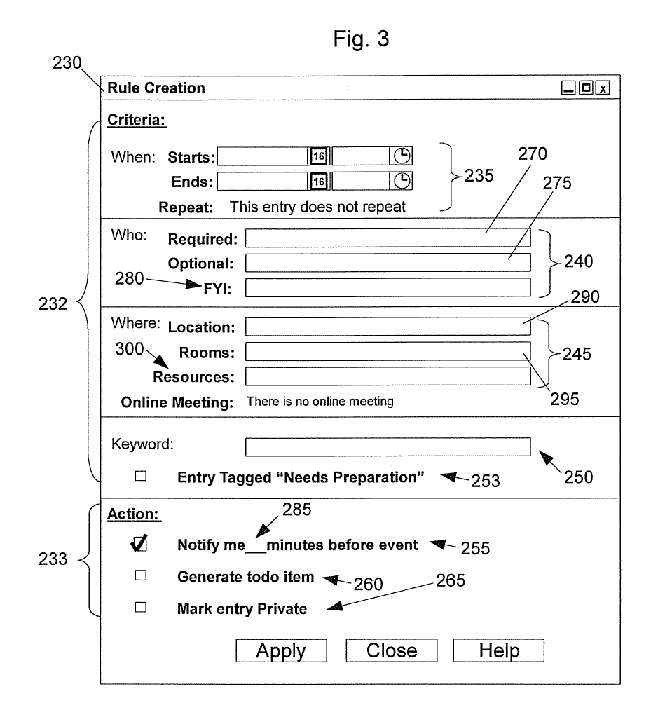

FIG. 3 depicts an embodiment of another user interface 230, such as rule creation dialog 230 for the creation of rules to apply to electronic calendar entries 202, for example. The rule creation dialog 230 is provided in response to selection of the create rules selector 225. An embodiment of the rule creation dialog 230 includes event rule criteria 232 to evaluate and event actions 233 to apply in response to a calendar appointment or event entry 202 that meets the event rule criteria 232.

In an embodiment, the event rule criteria 232 include appointment or event timing fields 235, participant fields 240, support fields 245, a keyword field 250, and a preparation status field 253. The event actions 233 include generating a reminder 255, generating a todo item 260, and marking the calendar entry private 265.

In view of the foregoing, non-limiting examples of rules that may be created and actions applied as relate to calendar entries 202 are described below. In response to entry of a particular identity within any of a required field 270, optional field 275, or FYI field 280 of the participant fields 240, any of the actions 233 may be taken, such as to provide an alarm reminder notification prior to the start of the event of the entry 202.

For example, if a participant John Doe is specified within the required field 270, and the generating a reminder 255 action 233 is selected, or specified with a time of 30 minutes entered in an advance notice duration field 285, any subsequent events or calendar entries 202 (best seen with reference to FIG. 2) that include John Doe within a required field of the participant fields 215 shall have a reminder of 30 minutes automatically applied to the entry within the calendar application 120.

As another example, if a participant John Doe is entered or specified within the required field 270, and the mark entry private 265 action 233 is selected, any subsequent entries 202 that include John Doe within a required field of the participant entry fields 215 (best seen with reference to FIG. 2) shall be marked as private events within the calendar application 120. It will be appreciated that multiple parties, such as John Doe, Jane Doe, and Tim Doe, for example, may be entered into any of the participant fields 240, and may further be entered into more than one of the participant fields 240, thereby defining the attributes of the calendar appointment or event entry 202 to evaluate.

As another example, in response to specification of a particular location or resource within any of a location field 290, rooms field 295, or resources field 300 of the support entry fields 245 (also herein referred to as a “resource criteria”), any of the actions 233 may be applied, such as to provide an alarm reminder notification prior to the start of the event that includes the specified location or resource.

For example, if a location such as Office A is specified within the location field 290, and the generating a reminder action 255 is selected with a time of 10 minutes entered in the notice field 285, any subsequent calendar appointment or event entry 202 that takes place with Office A within a location field of the support fields 220 of the shall have a reminder of 10 minutes automatically applied to the entry within the calendar application 120. It will be appreciated that a location such as Office B (at a greater distance than Office A) specified within the location field 290 may include a different time entered in the notice field 285, such as 20 minutes, for example.

As a further example, if a keyword, such as “flight” is specified within the keyword entry field 250, and the generating a reminder action 255 is selected with a time of 180 minutes entered in the notice field 285, the calendar application 120 shall apply the action 233 of generating the reminder 255 for any subsequent entry 202 that includes the word “flight”, such as within the subject entry field 205 of the calendar entry 202. In this way, additional reminder time to allow for transportation arrangements to an airport is available.

As an additional example, if the preparation status field 253 is selected, and the generating a todo item 260 action 233 is specified, any meeting that includes the “Needs Preparation” tag 223 will automatically generate a todo activity within the calendar application 120, such as to generate a todo activity having a due date that is the same as the date of the meeting that includes the “Needs Preparation” tag 223 for example.

While an embodiment has been described that utilizes the calendar entry dialog 200 to create calendar appointment or event entries 202, it will be appreciated that the scope of the invention is not so limited and shall also apply to embodiments of electronic calendar applications 120 in which calendar appointment or event entries 202 may be created by other means, such as acceptance of an appointment or event invitation, for example. Further, while the create rules selector 225 is described in conjunction with the calendar entry dialog 200, it will be appreciated that the scope of the invention is not so limited, and will also apply to embodiments of calendar applications 120 that include other interfaces, such as to include the create rules selector 225 to open the rule creation dialog 230 within an invitation interface that is received by a first user in response to the creation a calendar appointment or event by a second user, in which the second user has included the first user within one of the participant entry fields 215 of the calendar entry dialog 200.

Accordingly, use of the rule based processing of the calendar application 120 effectively sets up filters or personalized rules as criteria to apply actions to calendar appointment or event entries 202 within the user's electronic calendar based on attributes associated with each calendar appointment or event entry 202. Therefore, it saves the user the time and interface action necessary to manually apply different actions to each individual calendar appointment or event entry 202. Further, these filters or personalized rules can be expanded to the creation of additional objects, such as todo items for example, within the user's personal information management system.

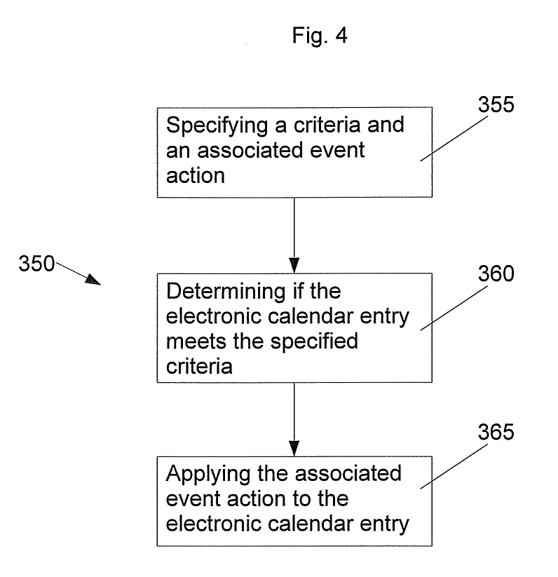

In view of the foregoing, the calendar application 120 facilitates a method of applying an action to an electronic calendar entry 202. Referring now to FIG. 4, a flowchart 350 of process steps of an embodiment of a method to apply an action to an electronic calendar entry 202 is depicted.

The process begins at step 355 with specifying the event rule criteria 232 and an associated event action 233 to apply to calendar entries 202 that meet the specified criteria 232. The process continues at step 360 with determining if attributes of the electronic calendar entry 202 meet the specified rule criteria 232. In response to determining at step 360 that the electronic calendar entry 202 meets the specified criteria, the method proceeds at Step 365 by applying the associated event action 233 to the electronic calendar entry 202.

Specifying the criteria 232 at step 355 can include one or more of the timing criteria 235, the participant criteria 240, the resource criteria 245, and the preparation status criteria 253. In one embodiment, the participant criteria 240 includes the required participant criteria 270. Specifying the associated event action 233 at step 355 to apply to the entry 202 can include one or more of generating the reminder action 255, generating the todo item action 260, and marking the entry private action 265. In one embodiment, generating the reminder action 255 includes the advance notice duration 285.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of applying an action to an electronic calendar entry, the method comprising:
specifying a criteria and an associated event action;
determining if the electronic calendar entry meets the specified criteria; and
in response to determining that the electronic calendar entry meets the specified criteria, applying the associated event action to the electronic calendar entry.

2. The method of claim 1, wherein the specifying the criteria comprises specifying at least one of:
a timing criteria;
a participant criteria;
a resource criteria;
a preparation status criteria; and
combinations thereof.

3. The method of claim 2, wherein the specifying the criteria comprises specifying a required participant criteria.

4. The method of claim 1, wherein the specifying the associated event action comprises specifying at least one of:
generating a reminder;
generating a todo item;
marking the electronic calendar entry as private.

5. The method of claim 4, wherein the associated event action comprises generating a reminder having an advance notice duration.
